(19) United States
(12) Patent Application Publication
(10) Pub. No.: US 2024/0251268 A1
(43) Pub. Date: Jul. 25, 2024

(54) MEASUREMENT REPORTING DELAY FOR PRE-CONFIGURED MEASUREMENT GAPS

(71) Applicant: Intel Corporation, Santa Clara, CA (US)

(72) Inventors: Rui Huang, Beijing, 11 (CN); Andrey Chervyakov, Nizhny Novgorod (RU); Meng Zhang, Beijing (CN); Hua Li, Arlington, VA (US); Ilya Bolotin, Nizhny-Novgorod (RU)

(21) Appl. No.: 18/290,415

(22) PCT Filed: Oct. 19, 2022
(86) PCT No.: PCT/US2022/047089

§ 371 Date: Nov. 13, 2023

Related U.S. Application Data
(60) Provisional application No. 63/257,909, filed on Oct. 20, 2021.

(51) Int. Cl. H04W 24/10; H04W 24/08

(52) U.S. Cl. CPC H04W 24/10; H04W 24/08

(57) ABSTRACT

A user equipment (UE) configured for operation in a fifth-generation new radio (5GNR) network performs Synchronization Signal Block (SSB) based Radio Resource Management (RRM) measurements with or without measurement gaps. The UE may decode network signalling or that triggers a status change of a pre-configured measurement gap. The UE may perform the SSB based RRM measurements with measurement gaps when the network signalling that triggered a pre-configured measurement gap status change activated the pre-configured measurement gap. The UE may deactivate the pre-configured measurement gap and perform the SSB based RRM measurements without measurement gaps when the network signalling that triggered a pre-configured measurement gap status change deactivated the pre-configured measurement gap. The UE may also encode a measurement report for transmission to the network which may include measurements results from the SSB based RRM measurements performed during a measurement reporting delay period. The number of samples of the SSB based RRM measurements that are included in the measurement report may be based at least in part on measurement gap status changes triggered during the measurement reporting delay period.

### PRIORITY CLAIM

This application claims priority to U.S. Provisional Patent Application Ser. No. 63/257,909, filed Oct. 20, 2021 [reference number AD9709-Z] which is incorporated herein by reference in its entirety.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks. Some embodiments relate to measurement reporting and event-triggered reporting.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

One issue with operating in a 5G NR network is measurement reporting. In an RRC_CONNECTED state, the UE measures multiple beams (at least one) of a cell and the measurements results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the best beams if the UE is configured to do so by the gNodeB (gNB).

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 is a block diagram of a user equipment (UE) in accordance with some embodiments; and

FIG. 3A illustrates measurement reporting delay without measurement gap activation status switching in accordance with some embodiments.

FIG. 3B illustrates measurement reporting delay with measurement gap activation status switching in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for operation in a fifth-generation new radio (5G NR) network. The UE performs Synchronization Signal Block (SSB) based Radio Resource Management (RRM) measurements with or without measurement gaps. The UE may encode a measurement report for transmission to the network which may include measurements results from the SSB based RRM measurements performed during a measurement reporting delay period. The number of samples of the SSB based RRM measurements that are included in the measurement report may be based at least in part on measurement gap status changes triggered during the measurement reporting delay period. In some embodiments, the UE may determine a length of the measurement reporting delay period depending on whether gap activation status switching occurred during the measurement reporting delay period. These embodiments as well as others are described in more detail below.

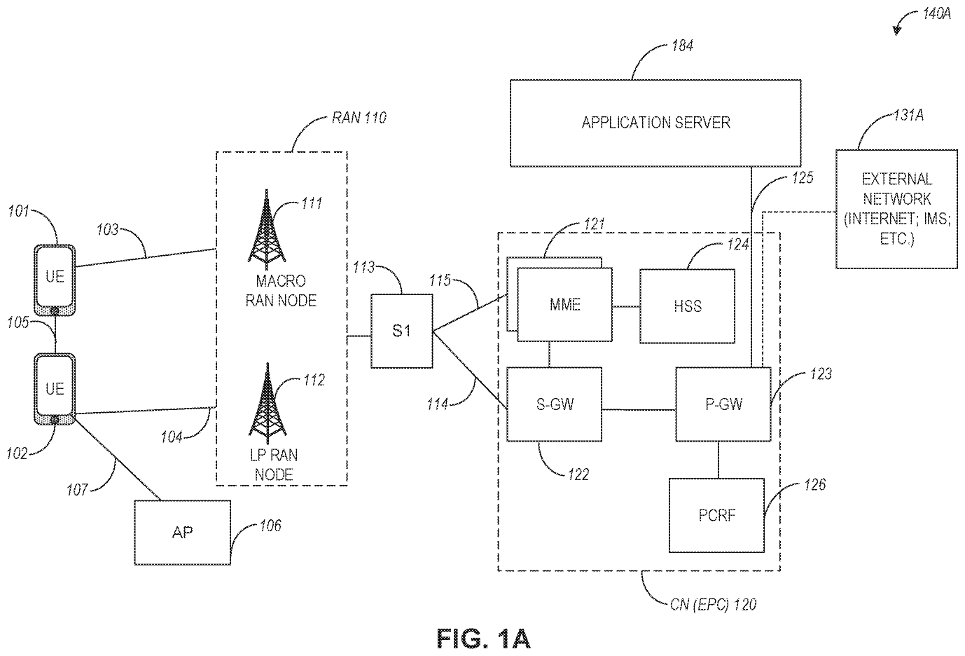

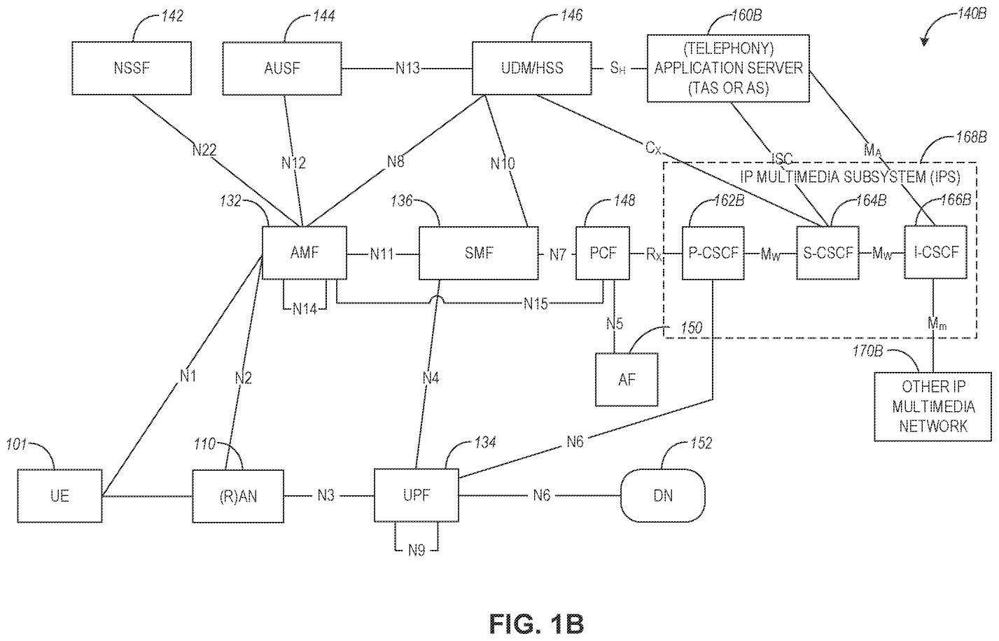

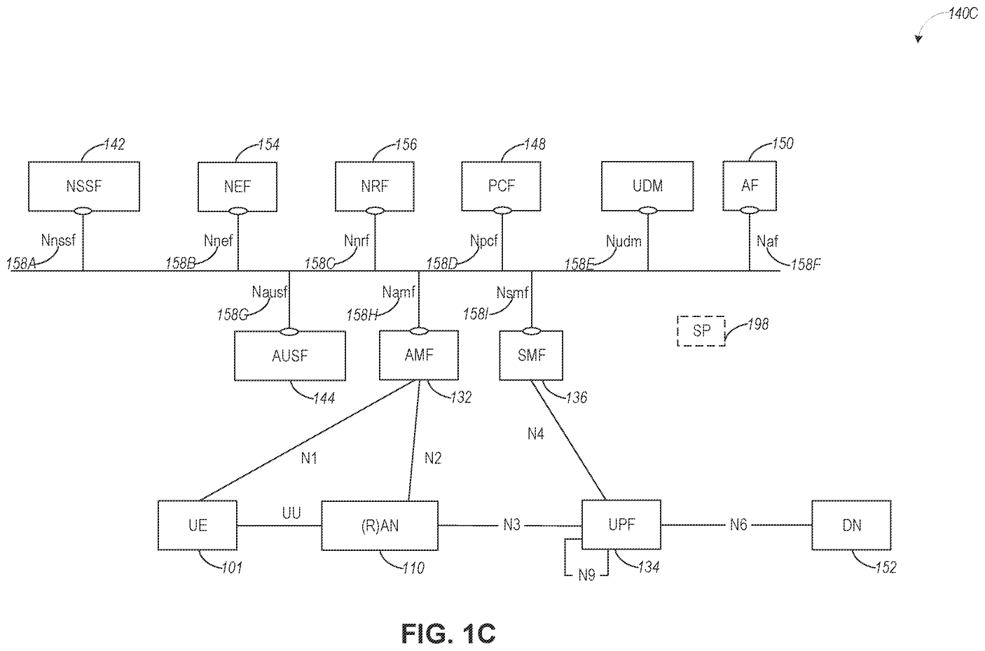

FIG. 1A illustrates an architecture of a network in accordance with some embodiments. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and further frequencies and Spectrum Access System (SAS) in 3.55-3.7 GHz and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UEs 101 and 102 can comprise an Internet-of-Things (IoT) UE or a Cellular IoT (CIoT) UE, which can comprise a network access layer designed for low-power IoT applications utilizing short-lived UE connections. In some embodiments, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V 15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

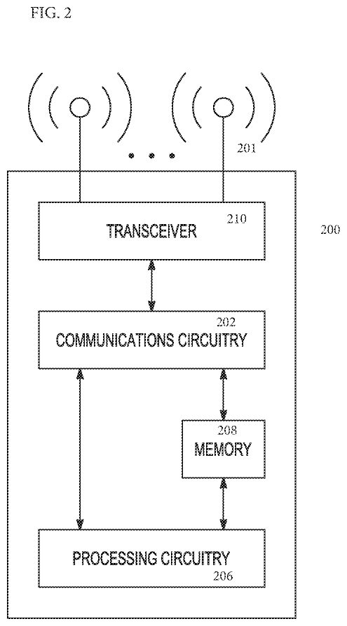

FIG. 2 illustrates a functional block diagram of a wireless communication device, in accordance with some embodiments. Wireless communication device 200 may be suitable for use as a UE or gNB configured for operation in a 5G NR network. The communication device 200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device.

The communication device 200 may include communications circuitry 202 and a transceiver 210 for transmitting and receiving signals to and from other communication devices using one or more antennas 201. The communications circuitry 202 may include circuitry that can operate the physical layer (PHY) communications and/or medium access control (MAC) communications for controlling access to the wireless medium, and/or any other communications layers for transmitting and receiving signals. The communication device 200 may also include processing circuitry 206 and memory 208 arranged to perform the operations described herein. In some embodiments, the communications circuitry 202 and the processing circuitry 206 may be configured to perform operations detailed in the above figures, diagrams, and flows.

In accordance with some embodiments, the communications circuitry 202 may be arranged to contend for a wireless medium and configure frames or packets for communicating over the wireless medium. The communications circuitry 202 may be arranged to transmit and receive signals. The communications circuitry 202 may also include circuitry for modulation/demodulation, upconversion/downconversion, filtering, amplification, etc. In some embodiments, the processing circuitry 206 of the communication device 200 may include one or more processors. In other embodiments, two or more antennas 201 may be coupled to the communications circuitry 202 arranged for sending and receiving signals. The memory 208 may store information for configuring the processing circuitry 206 to perform operations for configuring and transmitting message frames and performing the various operations described herein. The memory 208 may include any type of memory, including non-transitory memory, for storing information in a form readable by a machine (e.g., a computer). For example, the memory 208 may include a computer-readable storage device, read-only memory (ROM), random-access memory (RAM), magnetic disk storage media, optical storage media, flash-memory devices and other storage devices and media.

In some embodiments, the communication device 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 200 may include one or more antennas 201. The antennas 201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the communication device 200 may include one or more of a keyboard, a display, a non-volatile memory port, multiple antennas, a graphics processor, an application processor, speakers, and other mobile device elements. The display may be an LCD screen including a touch screen.

Although the communication device 200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 200 may refer to one or more processes operating on one or more processing elements.

Embodiments disclosed herein relate to NR measurement gap (MG) enhancement. Some embodiments related to pre-configured MG pattern(s) including fast MG configuration including the RRM requirements for pre-configured MG pattern(s). Embodiments disclosed herein also relate to the mechanisms for activation/deactivation of MG following a DCI or timer based BWP switch (e.g., per BWP MG configuration). Embodiments disclosed herein also relate to specification of rules and UE behavior for activation/deactivation of a MG following a DCI or timer based BWP switch. Embodiments disclosed herein also relate to defining a measurement period requirements with pre-configured MG pattern(s) in the presence of one or more BWP switch per measurement period.

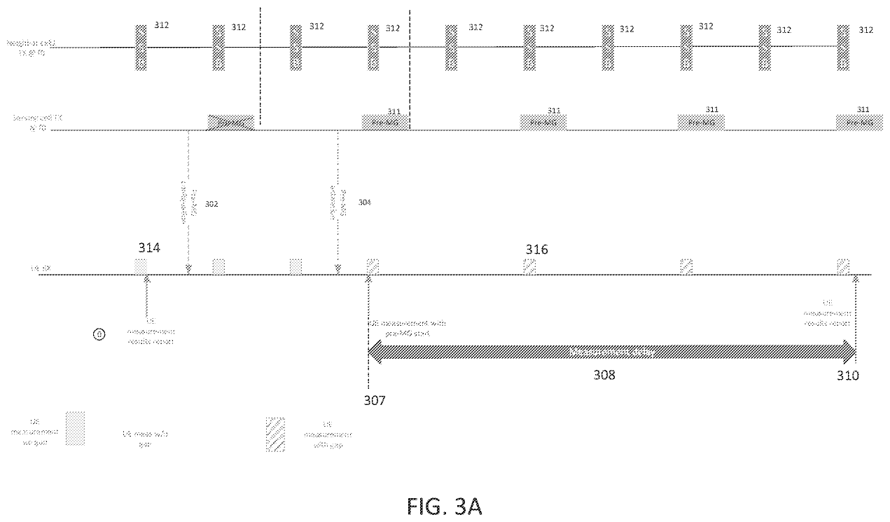

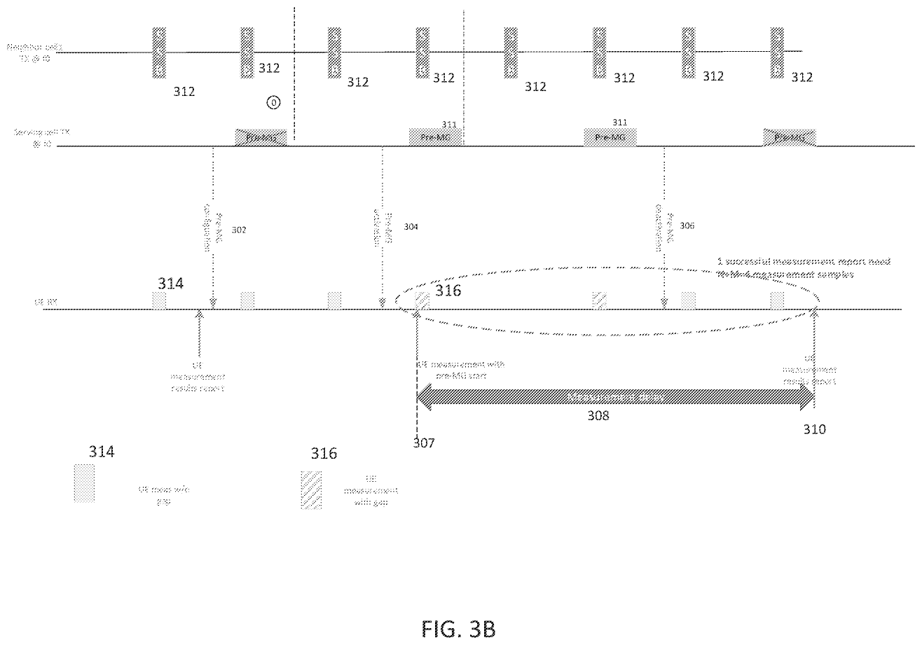

FIG. 3A illustrates measurement reporting delay without measurement gap activation status switching in accordance with some embodiments. FIG. 3B illustrates measurement reporting delay with measurement gap activation status switching in accordance with some embodiments.

As illustrated in FIGS. 3A and 3B, a user equipment (UE) configured for operation in a fifth-generation new radio (5G NR) network, may perform Synchronization Signal Block (SSB) based Radio Resource Management (RRM) measurements with or without measurement gaps 314. The UE may decode network signalling (either network signalling 304 or 306) that triggers a status change of a pre-configured measurement gap 311. The UE may perform the SSB based RRM measurements 316 with measurement gaps when the network signalling 304 that triggered a pre-configured measurement gap status change activated the pre-configured measurement gap 311. In these embodiments, the UE may deactivate the pre-configured measurement gap and perform the SSB based RRM measurements 314 without measurement gaps when the network signalling 306 that triggered a pre-configured measurement gap status change deactivated the pre-configured measurement gap 311. In these embodiments, the UE may also encode a measurement report 310 for transmission to the network. The measurement report may include measurements results from the SSB based RRM measurements performed during a measurement reporting delay period 308. In these embodiments, the number of samples of the SSB based RRM measurements that are included in the measurement report may be based at least in part on measurement gap status changes triggered during the measurement reporting delay period 308.

In some embodiments, the network signalling that triggers the status change of the pre-configured measurement gap 311 may comprise gap activation status switching. In these embodiments, the UE may determine a length of the measurement reporting delay period 308 depending on whether gap activation status switching occurred during the measurement reporting delay period 308. In these embodiments, the number of samples of the SSB based RRM measurements that are included in the measurement reporting delay period 308 may be based on whether gap activation status switching (i.e., a change in the MG status is triggered) occurred during the measurement reporting delay period 308. Accordingly, the length of the measurement reporting delay period 308 may depend on whether gap activation status switching occurred during the measurement reporting delay period 308 (i.e., when the UE decides to report the results).

In some embodiments, the network signalling (either network signalling 304 or 306) that triggers a status change of a pre-configured measurement gap 311 may comprise a downlink control information (DCI) format, although the scope of the embodiments is not limited in this respect.

In some embodiments, the UE may also be configured to decode radio-resource control (RRC) signalling 302 to configure the UE with a pre-configured measurement gap configuration for performing the SSB based RRM measurements 316 with the pre-configured measurement gaps 311. In these embodiments, the RRC signalling 302 may be received prior to the network signalling 304 that first activated the pre-configured measurement gap 311.

In some embodiments, the start of the measurement reporting delay period 308 begins after the network signalling 304 that first activated the pre-configured measurement gap 311. In these embodiments, the measurement reporting delay period 308 may begin at the first measurement gap after the network signalling 304. As illustrated in FIG. 3A and FIG. 3B, the measurement reporting delay period 308 begins at time 307 with pre-configured measurement gap 316 and ends at time 310. In some other embodiments, the start of the measurement reporting delay period 308 begins after bandwidth part (BWP) switching, although the scope of the embodiments is not limited in this respect.

In some embodiments, the UE may refrain from sending measurement results from any SSB based RRM measurements that were measured before receipt of the network signalling 304 that first activated the pre-configured measurement gap 311. In these embodiments, the SSB based RRM measurements that occurred prior to the activation (i.e., prior to receipt of network signalling 304) are not reported.

In some embodiments, when a status change of the pre-configured measurement gap 311 (e.g., a measurement gap status change) is not triggered during the measurement reporting delay period 308, the number of samples of the SSB based RRM measurements that are measured during the measurement reporting delay period 308 may be based on one of (i.e., either) a per-sample inter-frequency measurement period requirement and a per-sample intra-frequency measurement period requirement. In these embodiments, the per-sample inter-frequency measurement period requirement and the per-sample intra-frequency measurement period requirement may be in accordance with 3GPP TS 38.133, although the scope of the embodiments is not limited in this respect.

In some embodiments, when a status change of the pre-configured measurement gap 311 (e.g., a measurement gap status change) is triggered during the measurement reporting delay period 308, the number of samples of the SSB based RRM measurements that are measured during the measurement reporting delay period 308 may be determined based on at least one of: the per-sample inter-frequency measurement requirement multiplied by a number of inter-frequency measurement samples (i.e., N); the per-sample intra-frequency measurement requirement multiplied by a number of intra-frequency measurement samples (i.e., M), plus any additional samples based on a transition time for each measurement gap status change (i.e., K*transition time), although the scope of the embodiments is not limited in this respect.

In these embodiments, number of inter-frequency measurement samples (i.e., N) and the number of intra-frequency measurement samples (i.e., M) include samples from the SSB based RRM measurements with measurement gaps 316 and the SSB based RRM measurements without measurement gaps 314 (i.e., gapless and gap based measurements) up to a maximum predetermined number of samples (i.e., N+M<5). In these embodiments, the number of samples of the SSB based RRM measurements that are measured during the measurement reporting delay period 308 may be determined based on the intra-frequency measurement requirement of TS 38.133 per sample*N+the inter-frequency measurement requirement of TS 38.133 per sample*M+K*transition time, where, N+M are the total number of gapless and gap based measurements within a measurement report period, and N+M<5, and K is the number of measurement gap status changes during the measurement reporting delay period 308.

In some embodiments, when a status change of the pre-configured measurement gap 311 (e.g., a measurement gap status change) is triggered during the measurement reporting delay period 308, the number of samples of the SSB based RRM measurements that are measured during the measurement reporting delay period 308 may be determined based on a maximum of the per-sample inter-frequency measurement requirement and the per-sample intra-frequency measurement requirement multiplied by a predetermined number of samples (e.g., 5) plus any additional samples based on a transition time for each measurement gap status change (i.e., K*transition time), although the scope of the embodiments is not limited in this respect. In these embodiments, when a measurement gap status change is triggered during the measurement reporting delay period 308, the number of samples of the SSB based RRM measurements that are measured during the measurement reporting delay period 308 may be based on Max {Intra-frequency measurement requirement in 38.133 per sample, Inter-frequency measurement requirement in 38.133 per sample}*5+K*transition time.

In some embodiments, in response to receipt of the network signalling 304 that triggered a pre-configured measurement gap status change activating the pre-configured measurement gap 311, the UE may perform the SSB based RRM measurements 316 with measurement gaps and refrain from performance of the SSB based RRM measurements without measurement gaps. In these embodiments, in response to receipt of network signalling 306 that triggered a pre-configured measurement gap status change deactivating the pre-configured measurement gap 311, the UE may perform the SSB based RRM measurements 314 without measurement gaps and refrain from performance of the SSB based RRM measurements with measurement gaps.

In some embodiments, the SSB based RRM measurements may comprise measurements of one or more reference signals during SSB blocks 312 (i.e., SS/PBCH blocks) by the UE in an RRC connected state in which intra-frequency cells and/or inter-frequency cells and/or inter-RAT E-UTRAN cells may be identified and measured. During measurement gaps 311, the UE is not scheduled to receive data from its serving cell and may be able to switch to another carrier to perform the SSB based RRM measurements.

Some embodiments are directed to a non-transitory computer-readable storage medium that stores instructions for execution by processing circuitry of a user equipment (UE) configured for operation in a fifth-generation new radio (5G NR) network. In these embodiments, the processing circuitry may configure the UE to perform Synchronization Signal Block (SSB) based Radio Resource Management (RRM) measurements without measurement gaps 314. The processing circuitry may also configure the UE to decode network signalling (either network signalling 304 or 306) that triggers a status change of a pre-configured measurement gap 311. The UE may perform the SSB based RRM measurements 316 with measurement gaps when the network signalling 304 that triggered a pre-configured measurement gap status change activated the pre-configured measurement gap 311. The UE may also deactivate the pre-configured measurement gap and perform the SSB based RRM measurements 314 without measurement gaps when the network signalling 306 that triggered a pre-configured measurement gap status change deactivated the pre-configured measurement gap 311. The UE may also encode a measurement report 310 for transmission to the network. In these embodiments, the measurement report may include measurements results from the SSB based RRM measurements performed during a measurement reporting delay period 308. In these embodiments, the number of samples of the SSB based RRM measurements to include in the measurement report may be based at least in part on measurement gap status changes triggered during the measurement reporting delay period 308.

Some embodiments are directed to a gNodeB (gNB) configured for operation in a fifth-generation new radio (5G NR) network. In these embodiments, the gNB may be configured to encode network signalling (either network signalling 304 or 306) for transmission to a user equipment (UE) to triggers a status change of a pre-configured measurement gap 311. The gNB may be configured to decode a measurement report 310 received from the UE. In these embodiments, the measurement report may include measurements results from Synchronization Signal Block (SSB) based Radio Resource Management (RRM) measurements performed by the UE during a measurement reporting delay period 308. In these embodiments, the number of samples of the SSB based RRM measurements that are included in the measurement report may be based at least in part on measurement gap status changes triggered during the measurement reporting delay period 308.

In some embodiments, UE capability for UE measurements with the pre-configured gaps in NR is defined. For the measurement delay with a pre-configured MG configuration, it is noted that generally the measurement delay with a pre-configured MG is started at the first pre-configured MG activated. However, there may still be ongoing measurements after the last UE reporting and before the first pre-configured MG activated as shown in the FIG. 3A. To simplify these requirements, a UE can restart a new measurement process with the new pre-configured MG. In these embodiments, the unreported measurement results will be reset. In these embodiments, the measurement delay starts from the first pre-configured MG being activated.

In one embodiment, for a measurement delay with a pre-configured MG, it is noted that if there is no pre-configured MG activation/deactivation status switching during one successful measurement report process (which can include multiple UE measurement samples). In these embodiments, the measurements with pre-configured MG may be the same as inter-frequency measurements. On the other hand, if there is pre-configured MG activation/deactivation status switching during one successful measurement report process, such measurement process may be divided into two parts: one is a measurement with the pre-configured MG, the other measurement without a gap, as shown in FIG. 3B. Thus, the measurement delay can be composed by at least: an intra-frequency measurement requirement per sample and the inter-frequency measurement requirement per sample.

In comparison with the measurement with a legacy MG, the measurement with a pre-configured MG may need more time due to the gap transition. In these embodiments, the measurement delay with pre-configured MG may be defined as dependent on whether there is an activation/deactivation status change within a period of measurement report. This is illustrated in the table below.

| Scenario | Measurement delay |
|---|---|
| NO switching | Inter-frequency measurement requirement in 38.133 |
| Switching | Intra-frequency measurement requirement in 38.133 |
| | per sample * N + Inter-frequency measurement require- |
| | ment in 38.133 per sample * M + K *transition time |
| | Wherein, N and M is the total number of gapless and |
| | gap based measurements within a measurement report |
| | period, and N + M < [5] K is the number of total number |
| | pre-configured MG activation status transition. |

In some alternate embodiments, for simplicity, these requirements may be defined for the scenario in which no any pre-configured MG status switching occurred. Given this assumption, if a new pre-configured MG is used for the measurement after the BWP switching, the measurement delay itself will be not different with other legacy gap as the measurement procedure start from the first gap after BWP switching. The impact on the measurement minimum performance requirement (e.g. cell detection delay, measurement period etc.) is little. Therefore, the measurement delay requirements may be same as intra-frequency measurement with a scheduling restriction.

In some embodiments, the measurements with pre-configured MG can follow that of inter-frequency SSB/CSI-RS measurement requirements. In these embodiments, the total measurement requirement may be defined by the max of an intra-frequency measurement requirement per sample and an inter-frequency measurement requirement per sample. This is illustrated in the table below.

| Scenario | Measurement delay |
|---|---|
| NO switching | Inter-frequency measurement requirement in 38.133 |
| Switching | Max{Intra-frequency measurement requirement in |
| | 38.133 per sample, Inter-frequency measurement |
| | requirement in 38.133 per sample}* [5] + K |
| | *transition time |
| | Wherein, |
| | K is the number of total number pre-configured |
| | MG activation status transition. |

In some embodiments, the measurement delay requirements are defined for a pre-configured gap based measurements. In some embodiments, the starting point of measurement delay may be the first activated pre-configure gap. In some embodiments, the measurement delay with pre-configured MG may be defined depending on whether there is activation/deactivation status changed within a period of measurement. In some embodiments, if there is no any pre-configured gap activation status switching during a period of UE measurement report, the delay can be based on Inter-frequency measurement requirement in TS 38.133. In some embodiments, if there is a pre-configured gap activation status switching during a period of UE measurement report, the delay may be based on both inter-frequency measurement requirement and intra-frequency measurement in TS 38.133. In some embodiments, if there is a pre-configured gap activation status switching during a period of UE measurement report, the delay can be based on max{inter-frequency measurement requirement per a sample, intra-frequency measurement per a sample} as defined in TS 38.133. In some embodiments, if there is some pre-configured gap activation status switching during a period of UE measurement report, the delay may be based on inter-frequency measurement requirement per a sample only.

In some embodiments, the measurement reporting delay may be defined as the time between an event that will trigger a measurement report and the point when the UE starts to transmit the measurement report over the air interface. This requirement assumes that the measurement report is not delayed by other RRC signalling on the DCCH. This measurement reporting delay excludes a delay uncertainty resulted when inserting the measurement report to the TTI of the uplink DCCH. The delay uncertainty is: 2×TTI_{DCCH}. This measurement reporting delay excludes a delay which caused by no UL resources being available for UE to send the measurement report on.

The event triggered measurement reporting delay, measured without L3 filtering shall be less than T_{identify intra with index} or T_{identify intra without index}. When L3 filtering is used an additional delay can be expected. In EN-DC and NE-DC operation, when the UE is configured to perform E-UTRA SRS carrier-based switching an additional delay can be expected in FR1 if the UE is capable of per-FR gap, or an additional delay can be expected in both FR1 and FR2 if the UE is not capable of per-FR gap.

A cell is detectable only if at least one SSBs measured from the Cell being configured remains detectable during the time period T_{identify_intra_without_index} Or T_{identify_intra_with_index}. If a cell which has been detectable at least for the time period T_{identify_intra_without_index} Or T_{identify_intra_with_index} becomes undetectable for a period≤5 seconds and then the cell becomes detectable again with the same spatial reception parameter and triggers an event, the event triggered measurement reporting delay shall be less than T_{SSB_measurement_period_intra} provided the timing to that cell has not changed more than ±3200/²^{^{μ}} T_{c} while the measurement gap has not been available and L3 filtering has not been used, where μ is the SCS configuration. When L3 filtering is used, an additional delay can be expected.

A measurement is defined as a SSB based intra-frequency measurement provided the center frequency of the SSB of the serving cell indicated for measurement and the center frequency of the SSB of the neighbour cell are the same, and the subcarrier spacing of the two SSBs are also the same. The UE shall be able to identify new intra-frequency cells and perform SS-RSRP, SS-RSRQ, and SS-SINR measurements of identified intra-frequency cells if carrier frequency information is provided by PCell or the PSCell, even if no explicit neighbour list with physical layer cell identities is provided. The UE can perform intra-frequency SSB based measurements without measurement gaps (either legacy measurement gap or NCSG) if the UE indicates ‘no-gap’ via intraFreq-needForGap for intra-frequency measurement, or the SSB is completely contained in the active BWP of the UE, or the active downlink BWP is an initial BWP.

When a measurement gap is provided or an activated Pre-MG is provided without any pre-MG status changed during the measurement period, the UE shall be able to identify a new detectable intra frequency cell within T_{identify_intra_without_index} if UE is not indicated to report SSB based RRM measurement result with the associated SSB index (reportQuantityRsIndexes or maxNrofRSIndexesToReport is not configured), or the UE has been indicated that the neighbour cell is synchronous with the serving cell (deriveSSB-IndexFromCell is enabled). Otherwise UE shall be able to identify a new detectable intra frequency cell within T_{identify_intra_with_index}. The UE shall be able to identify a new detectable intra frequency SS block of an already detected cell within T_{identify_intra_without_index}. It is assumed that deriveSSB-IndexFromCell is always enabled for FR1 TDD and FR2.

$${T}_{identify \_ intra \_ without \_ index} = {T}_{P S S / SSS \_ sync \_ intra} + {T}_{SSB \_ measurement \_ period \_ intra} ms$$

$${T}_{identify \_ intra \_ with \_ index} = {T}_{P S S / SSS \_ sync \_ ntra} + {T}_{SSB \_ measurement \_ period \_ intra} + {T}_{SSB \_ time \_ intra} ms$$

Where: T_{PSS/SSS_sync_intra}: it is the time period used in PSS/SSS detection given in table 9.2.6.2-1, 9.2.6.2-2, T_{SSB_time_index_intra}: it is the time period used to acquire the index of the SSB being measured given in table 9.2.6.2-3, T_{SSB_measurement_period_intra}: equal to a measurement period of SSB based measurement given in table 9.2.6.3-1 or 9.2.6.3-2, CSSFᵢₙₜᵣₐ: it is a carrier specific scaling factor and is determined according to CSSF_{within_gap,i} for measurement conducted within measurement gaps, and K_{gap} is the scaling factor for a SSB frequency layer to be measured within an associated measurement gap pattern. K_{gap}=1 when the UE is not configured with concurrent measurement gaps or not supporting [concurrent measurement gaps].

When a measurement gap is provided or when an activated Pre-MG is provided without any pre-MG status changed during the measurement period, the measurement period for FR1 intrafrequency measurements with gaps is as shown in table 9.2.6.3-1, and the measurement period for FR2 intrafrequency measurements with gaps is as shown in table 9.2.6.3-2.

Table 9.2.6.3-1: Measurement period for intra-frequency measurements with gaps (FR1)

| DRX cycle | T_{SSB}_{_{—}}ₘₑₐₛᵤᵣₑₘₑₙₜ_{_{—}}_{period}_{_{—}}ᵢₙₜᵣₐ |
|---|---|
| No DRX | max(200 ms, ceil(5 × K_{gap}) × max(MGRP, |
| | SMTC period)) × CSSFᵢₙₜᵣₐ |
| DRX cycle ≤ 320 ms | max(200 ms, ceil(1.5 × 5 × K_{gap}) × max(MGRP, |
| | SMTC period, DRX cycle)) × CSSFᵢₙₜᵣₐ |
| DRX cycle > 320 ms | Ceil(5 × K_{gap}) × max(MGRP, DRX cycle) × |
| | CSSFᵢₙₜᵣₐ |

NOTE 1:
For a UE supporting concurrent gaps, if multiple concurrent gaps are configured, the MGRP is the periodicity of the MG pattern associated to the intra-frequency layer.

Table 9.2.6.3-2: Measurement period for intra-frequency measurements with gaps (FR2)

| DRX cycle | T_{SSB}_{_{—}}ₘₑₐₛᵤᵣₑₘₑₙₜ_{_{—}}_{period}_{_{—}}ᵢₙₜᵣₐ |
|---|---|
| No DRX | max(400 ms, ceil(Mₘₑₐₛ_{_{—}}_{period with}_{_{—}}_{gaps} × |
| | K_{gap}) × max(MGRP, SMTC period)) × CSSFᵢₙₜᵣₐ |
| DRX cycle ≤ 320 ms | max(400 ms, ceil(1.5 × Mₘₑₐₛ_{_{—}}_{period with}_{_{—}}_{gaps} × |
| | K_{gap}) × max(MGRP, SMTC period, DRX |
| | cycle)) ^{Note 1} × CSSFᵢₙₜᵣₐ |
| DRX cycle > 320 ms | Ceil(Mₘₑₐₛ_{_{—}}_{period with}_{_{—}}_{gaps} × K_{gap}) × |
| | max(MGRP, DRX cycle) × CSSFᵢₙₜᵣₐ |

^{NOTE 1}
For a UE supporting concurrent gaps, if multiple concurrent gaps are configured, the MGRP is the periodicity of the MG pattern associated to the intra-frequency layer.

Intra-frequency neighbour (cell) measurements and inter-frequency neighbour (cell) measurements are defined as follows: SSB based intra-frequency measurement: a measurement is defined as an SSB based intra-frequency measurement provided the center frequency of the SSB of the serving cell and the center frequency of the SSB of the neighbour cell are the same, and the subcarrier spacing of the two SSBs is also the same. SSB based inter-frequency measurement: a measurement is defined as an SSB based inter-frequency measurement provided the center frequency of the SSB of the serving cell and the center frequency of the SSB of the neighbour cell are different, or the subcarrier spacing of the two SSBs is different.

Whether a measurement is non-gap-assisted or gap-assisted depends on the capability of the UE, the active BWP of the UE and the current operating frequency. For SSB based inter-frequency measurement, if the measurement gap requirement information is reported by the UE, a measurement gap configuration may be provided according to the information. Otherwise, a measurement gap configuration is always provided in the following cases: If the UE only supports per-UE measurement gaps. If the UE supports per-FR measurement gaps and any of the serving cells are in the same frequency range of the measurement object.

For SSB based intra-frequency measurement, if the measurement gap requirement information is reported by the UE, a measurement gap configuration may be provided according to the information. Otherwise, a measurement gap configuration is always provided in the following case. Other than the initial BWP, if any of the UE configured BWPs do not contain the frequency domain resources of the SSB associated to the initial DL BWP. In non-gap-assisted scenarios, the UE shall be able to carry out such measurements without measurement gaps. In gap-assisted scenarios, the UE cannot be assumed to be able to carry out such measurements without measurement gaps.

In some embodiments, the number of samples included in a measurement report may be determined by the UE based on reliability (i.e., enough to meet a reliability requirement), although the scope of the embodiments is not limited in this respect. In some embodiments, the UE may transmit a ‘needs for gap’ information element to the network when a measurement gap configuration is needed for performing measurements.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a user equipment (UE) configured for operation in a fifth-generation new radio (5G NR) network, the apparatus comprising:
processing circuitry; and memory, wherein the processing circuitry is to configure the UE to:
perform Synchronization Signal Block (SSB) based Radio Resource Management (RRM) measurements without measurement gaps;
decode network signalling that triggers a status change of a pre-configured measurement gap;
perform the SSB based RRM measurements with measurement gaps when the network signalling that triggered a pre-configured measurement gap status change activated the pre-configured measurement gap;
deactivate the pre-configured measurement gap and perform the SSB based RRM measurements without measurement gaps when the network signalling that triggered a pre-configured measurement gap status change deactivated the pre-configured measurement gap; and
encode a measurement report for transmission to the network, the measurement report encoded to include measurements results from the SSB based RRM measurements performed during a measurement reporting delay period,
wherein a number of samples of the SSB based RRM measurements to include in the measurement report is based at least in part on measurement gap status changes triggered during the measurement reporting delay period, and
wherein the memory is configured to store the measurement report.

2. The apparatus of claim 1, wherein the network signalling that triggers the status change of the pre-configured measurement gap comprises gap activation status switching, and
wherein the processing circuitry is configured to determine a length of the measurement reporting delay period depending on whether gap activation status switching occurred during the measurement reporting delay period.

3. The apparatus of claim 2, wherein the processing circuitry is further configured to decode radio-resource control (RRC) signalling to configure the UE with a pre-configured measurement gap configuration for performing the SSB based RRM measurements with the pre-configured measurement gaps, the RRC signalling received prior to the network signalling that activated the pre-configured measurement gap.

4. The apparatus of claim 3, wherein a start of the measurement reporting delay period begins after the network signalling that activated the pre-configured measurement gap.

5. The apparatus of claim 4, wherein the processing circuitry is to further configure the UE to refrain from sending measurement results from any SSB based RRM measurements that were measured before receipt of the network signalling that activated the pre-configured measurement gap.

6. The apparatus of claim 5, wherein when a status change of the pre-configured measurement gap (e.g., a measurement gap status change) is not triggered during the measurement reporting delay period, the number of samples of the SSB based RRM measurements that are measured during the measurement reporting delay period is based on one of a per-sample inter-frequency measurement period requirement and a per-sample intra-frequency measurement period requirement.

7. The apparatus of claim 6, wherein when a status change of the pre-configured measurement gap (e.g., a measurement gap status change) is triggered during the measurement reporting delay period, the number of samples of the SSB based RRM measurements that are measured during the measurement reporting delay period is determined based on at least one of:
the per-sample inter-frequency measurement requirement multiplied by a number of inter-frequency measurement samples;
the per-sample intra-frequency measurement requirement multiplied by a number of intra-frequency measurement samples,
plus any additional samples based on a transition time for each measurement gap status change.
wherein number of inter-frequency measurement samples and the number of intra-frequency measurement samples include samples from the SSB based RRM measurements with measurement gaps and the SSB based RRM measurements without measurement gaps up to a maximum predetermined number of samples.

8. The apparatus of claim 6, wherein when a status change of the pre-configured measurement gap is triggered during the measurement reporting delay period, the number of samples of the SSB based RRM measurements that are measured during the measurement reporting delay period is determined based on a maximum of the per-sample inter-frequency measurement requirement and the per-sample intra-frequency measurement requirement multiplied by a predetermined number of samples plus any additional samples based on a transition time for each measurement gap status change.

9. The apparatus of any of claim 7 or 8, wherein in response to receipt of the network signalling that triggered a pre-configured measurement gap status change activating the pre-configured measurement gap, the processing circuitry is configured to perform the SSB based RRM measurements with measurement gaps and refrain from performance of the SSB based RRM measurements without measurement gaps, and
wherein in response to receipt of network signalling that triggered a pre-configured measurement gap status change deactivating the pre-configured measurement gap, the processing circuitry is configured to perform the SSB based RRM measurements without measurement gaps and refrain from performance of the SSB based RRM measurements with measurement gaps.

10. The apparatus of claim 1, wherein the SSB based RRM measurements comprise measurements of one or more reference signals during SSB blocks by the UE in an RRC connected state in which intra-frequency cells and/or inter-frequency cells and/or inter-RAT E-UTRAN cells are identified and measured.

11. A non-transitory computer-readable storage medium that stores instructions for execution by processing circuitry of a user equipment (UE) configured for operation in a fifth-generation new radio (5G NR) network, wherein the processing circuitry is to configure the UE to:
perform Synchronization Signal Block (SSB) based Radio Resource Management (RRM) measurements without measurement gaps;
decode network signalling that triggers a status change of a pre-configured measurement gap;
perform the SSB based RRM measurements with measurement gaps when the network signalling that triggered a pre-configured measurement gap status change activated the pre-configured measurement gap;
deactivate the pre-configured measurement gap and perform the SSB based RRM measurements without measurement gaps when the network signalling that triggered a pre-configured measurement gap status change deactivated the pre-configured measurement gap; and
encode a measurement report for transmission to the network, the measurement report encoded to include measurements results from the SSB based RRM measurements performed during a measurement reporting delay period,
wherein a number of samples of the SSB based RRM measurements to include in the measurement report is based at least in part on measurement gap status changes triggered during the measurement reporting delay period.

12. The non-transitory computer-readable storage medium of claim 11, wherein the network signalling that triggers the status change of the pre-configured measurement gap comprises gap activation status switching, and
wherein the processing circuitry is configured to determine a length of the measurement reporting delay period depending on whether gap activation status switching occurred during the measurement reporting delay period.

13. The non-transitory computer-readable storage medium of claim 12, wherein the processing circuitry is further configured to decode radio-resource control (RRC) signalling to configure the UE with a pre-configured measurement gap configuration for performing the SSB based RRM measurements with the pre-configured measurement gaps, the RRC signalling received prior to the network signalling that activated the pre-configured measurement gap.

14. The non-transitory computer-readable storage medium of claim 13, wherein a start of the measurement reporting delay period begins after the network signalling that activated the pre-configured measurement gap.

15. The non-transitory computer-readable storage medium of claim 14, wherein the processing circuitry is to further configure the UE to refrain from sending measurement results from any SSB based RRM measurements that were measured before receipt of the network signalling that activated the pre-configured measurement gap.

16. The non-transitory computer-readable storage medium of claim 15, wherein when a status change of the pre-configured measurement gap (e.g., a measurement gap status change) is not triggered during the measurement reporting delay period, the number of samples of the SSB based RRM measurements that are measured during the measurement reporting delay period is based on one of a per-sample inter-frequency measurement period requirement and a per-sample intra-frequency measurement period requirement.

17. The non-transitory computer-readable storage medium of claim 16, wherein when a status change of the pre-configured measurement gap (e.g., a measurement gap status change) is triggered during the measurement reporting delay period, the number of samples of the SSB based RRM measurements that are measured during the measurement reporting delay period is determined based on at least one of:
the per-sample inter-frequency measurement requirement multiplied by a number of inter-frequency measurement samples;
the per-sample intra-frequency measurement requirement multiplied by a number of intra-frequency measurement samples,
plus any additional samples based on a transition time for each measurement gap status change.
wherein number of inter-frequency measurement samples and the number of intra-frequency measurement samples include samples from the SSB based RRM measurements with measurement gaps and the SSB based RRM measurements without measurement gaps up to a maximum predetermined number of samples.

18. An apparatus for a gNodeB (gNB) configured for operation in a fifth-generation new radio (5G NR) network, the apparatus comprising: processing circuitry; and memory, wherein the processing circuitry is to configure the gNB to:
encode network signalling for transmission to a user equipment (UE) to triggers a status change of a pre-configured measurement gap; and
decode a measurement report received from the UE, the measurement report including measurements results from Synchronization Signal Block (SSB) based Radio Resource Management (RRM) measurements performed by the UE during a measurement reporting delay period,
wherein a number of samples of the SSB based RRM measurements that are included in the measurement report is based at least in part on measurement gap status changes triggered during the measurement reporting delay period, and
wherein the memory is configured to store the measurement report.

19. The apparatus of claim 18 wherein when the network signalling that triggers a pre-configured measurement gap status change activated the pre-configured measurement gap, the UE is to perform the SSB based RRM measurements with measurement gaps, and
when the network signalling that triggers a pre-configured measurement gap status change deactivated the pre-configured measurement gap, the UE is to perform the SSB based RRM measurements without measurement gaps,

20. The apparatus of claim 19, wherein the network signalling that triggers the status change of the pre-configured measurement gap comprises gap activation status switching, and
wherein a length of the measurement reporting delay period is dependent on whether gap activation status switching occurred during the measurement reporting delay period.
